(19) United States
(12) Patent Application Publication
(10) Pub. No.: US 2003/0217995 A1
(43) Pub. Date: Nov. 27, 2003

(54) Laser processing method using ultra-short pulse laser beam

(76) Inventors: Yosuke Toyofuku, Kasuga-shi (JP); Yosuke Mizuyama, Munakata-gun (JP)

Correspondence Address: HARNESS, DICKEY & PIERCE, P.L.C., P.O. BOX 828, BLOOMFIELD HILLS, MI, 48303, US

(21) Appl. No.: 10/154,122

(22) Filed: May 23, 2002

(51) Int. Cl. B23K 26/38; B23K 26/14

(52) U.S. Cl. 219/121.71; 219/121.84

(57) ABSTRACT

A laser processing apparatus includes an ultra-short pulse laser for outputting a laser beam having a pulse width of 0.1 to 100 ps, and an attenuator for adjusting the energy of the laser beam. Minute nozzles are formed in a nozzle plate made of a metal by using an ultra-short pulse laser beam whose processing energy is 300 mJ/cm² or more.

### BACKGROUND OF THE INVENTION

1. Field of the Invention

The present invention relates to a laser processing method using an ultra-short pulse laser beam.

2. Description of the Background Art

In recent years, there is a demand in the laser industry for laser processing techniques capable of processing a workpiece minutely and with a high precision. Particularly, the minute processing capability of short pulse laser beams has been attracting public attention.

The variety of applications requiring such minute processing has also been growing. For example, one of such applications is a nozzle plate used in an ink jet head. Along with the recent improvements in the printing speed and the image quality of ink jet printers, nozzles of the nozzle plate have been miniaturized, and there is a demand for a high-performance laser processing technique for making such minute nozzles with a high precision.

In a minute process, since even a slight decrease in the process precision leads to a substantial decrease in the yield, there is a strong demand for improving the process precision. However, with a conventional laser process, which is a heat process, processed portions of a workpiece being processed are melted, and it is thus difficult to obtain an intended precision and shape.

In view of this, we, the inventors of the present invention, made researches on the use of a laser pulse, having a very short pulse width and a high intensity, at a relatively low frequency. As a result, we conceived a processing technique using an ultra-short pulse laser beam whose oscillation pulse width is about 0.1 ps to about 100 ps, as a high-precision laser processing technique. A process using such an ultra-short pulse laser beam is a cold process and is thus capable of eliminating problems associated with a heat process as described above.

However, our attempts to actually process a workpiece using an ultra-short pulse laser beam have revealed that by simply reducing the oscillation pulse width, the surface of a workpiece will be rough and have bump-like irregularities whose size is on the order of microns. Such surface irregularities and surface roughness are undesirable as they lower the quality of the workpiece.

Particularly, such surface irregularities or surface roughness occurring in a nozzle of a nozzle plate of an ink jet head will block the flow of an ink flowing toward the nozzle exit. This, in some cases, causes an unnecessary disturbance in the ink flow, thereby deviating the ink discharging direction or shifting the ink discharging velocity from the design value. This may in turn cause a shift in the landing position of an ink droplet discharged from a nozzle, and a shift in the printing position, etc., of the ink jet head, leading to problems such as defective printing. Thus, simply employing an ultra-short pulse laser may lead to problems such as a decrease in the printing quality.

### SUMMARY OF THE INVENTION

An object of the present invention is to realize a high-quality laser process using an ultra-short pulse laser beam by suppressing the surface irregularities or surface roughness of a workpiece.

A laser processing method of the present invention is a laser processing method, including the step of processing a workpiece made of a metal by using an ultra-short pulse laser beam, wherein an energy applied on a processed surface of the workpiece is 300 mJ/cm² or more.

In this way, there is very little melting of processed portions, and the processed portions evaporate instantaneously, thereby suppressing the surface roughness or surface irregularities on the processed surface of the workpiece.

It is preferred that: the workpiece contains an oxide including one or both of an Al oxide and an Mg oxide; and the energy applied on the processed surface of the workpiece is 400 mJ/cm² or more.

It is preferred that a gas is blown to the workpiece being processed with a blow pressure of 15 psi or more.

It is preferred that: the workpiece contains an oxide including one or both of an Al oxide and an Mg oxide; and the number of locations per 1000 mm² of an arbitrary cross section of the workpiece where the oxide is exposed is 20 or less.

It is preferred that: the workpiece contains an oxide including one or both of an Al oxide and an Mg oxide; the energy applied on the processed surface of the workpiece is 400 mJ/cm² or more; and a gas is blown to the workpiece being processed with a blow pressure of 15 psi or more.

It is preferred that: the workpiece contains an oxide including one or both of an Al oxide and an Mg oxide; the energy applied on the processed surface of the workpiece is 300 mJ/cm² or more; and the number of locations per 1000 mm² of an arbitrary cross section of the workpiece where the oxide is exposed is 20 or less.

It is preferred that: the workpiece contains an oxide including one or both of an Al oxide and an Mg oxide; the number of locations per 1000 mm² of an arbitrary cross section of the workpiece where the oxide is exposed is 20 or less; and a gas is blown to the workpiece being processed with a blow pressure of 15 psi or more.

It is preferred that: the workpiece contains an oxide including one or both of an Al oxide and an Mg oxide; the energy applied on the processed surface of the workpiece is 300 mJ/cm² or more; the number of locations per 1000 mm² of an arbitrary cross section of the workpiece where the oxide is exposed is 20 or less; and a gas is blown to the workpiece being processed with a blow pressure of 15 psi or more.

Another laser processing method of the present invention is a laser processing method, including the step of processing a workpiece by using an ultra-short pulse laser beam, wherein: the workpiece contains an oxide including one or both of an Al oxide and an Mg oxide; and the energy applied on the processed surface of the workpiece is 400 mJ/cm² or more.

In this way, the surface roughness or surface irregularities on the processed surface of the workpiece can be suppressed.

It is preferred that a gas is blown to the workpiece being processed with a blow pressure of 15 psi or more.

It is preferred that: the workpiece contains an oxide including one or both of an Al oxide and an Mg oxide; and the number of locations per 1000 mm² of an arbitrary cross section of the workpiece where the oxide is exposed is 20 or less.

It is preferred that: the number of locations per 1000 mm² of an arbitrary cross section of the workpiece where the oxide is exposed is 20 or less; and a gas is blown to the workpiece being processed with a blow pressure of 15 psi or more.

Still another laser processing method of the present invention is a laser processing method, including the step of processing a workpiece made of a metal by using an ultra-short pulse laser beam, wherein a gas is blown to the workpiece being processed with a blow pressure of 15 psi or more.

In this way, the surface roughness or surface irregularities on the processed surface of the workpiece can be suppressed.

It is preferred that: the workpiece contains an oxide including one or both of an Al oxide and an Mg oxide; and the number of locations per 1000 mm² of an arbitrary cross section of the workpiece where the oxide is exposed is 20 or less.

Still another laser processing method of the present invention is a laser processing method, including the step of processing a workpiece by using an ultra-short pulse laser beam, wherein: the workpiece contains an oxide including one or both of an Al oxide and an Mg oxide; and the number of locations per 1000 mm² of an arbitrary cross section of the workpiece where the oxide is exposed is 20 or less.

In this way, the surface roughness or surface irregularities on the processed surface of the workpiece can be suppressed.

The workpiece may be a nozzle plate of an ink jet head.

In this way, the surface roughness or surface irregularities on the nozzle surface of the nozzle plate can be suppressed, and a high-quality nozzle plate can be obtained.

It is preferred that a pulse width of the ultra-short pulse laser beam is 0.1 ps to 100 ps.

In this way, melting of the workpiece is suppressed, and an effective cold process is performed.

If the pulse width is 4 ps or more, the limitation on the hologram used in the laser processing apparatus is reduced. Therefore, the pulse width of the ultra-short pulse laser beam is more preferably 4 ps or more, and even more preferably 10 to 20 ps.

### BRIEF DESCRIPTION OF THE DRAWINGS

FIG. 1 is a cross-sectional view illustrating a portion of an ink jet head.

FIG. 2 is a cross-sectional view illustrating a portion of a nozzle plate.

FIG. 3 illustrates a configuration of a laser processing apparatus.

FIG. 4 is an enlarged perspective view illustrating a portion of a nozzle plate being processed.

FIG. 5 is a graph illustrating the relationship between the processing energy and the maximum value of the surface roughness.

FIG. 6 is a graph illustrating the relationship between the processing energy and the bump count.

FIG. 7 is a schematic diagram illustrating a laser process being performed while supplying a blow gas.

FIG. 8 is a graph illustrating the relationship between the blow gas pressure and the maximum value of the surface roughness.

FIG. 9 is a diagram illustrating oxide particles being exposed on a nozzle plate.

FIG. 10 is a graph illustrating the relationship between the oxide count and the bump count.

### DESCRIPTION OF THE PREFERRED EMBODIMENT

An embodiment of the present invention will now be described with reference to the drawings.

In the present embodiment, a laser processing method of the present invention is used for making nozzles in a nozzle plate of an ink jet head.

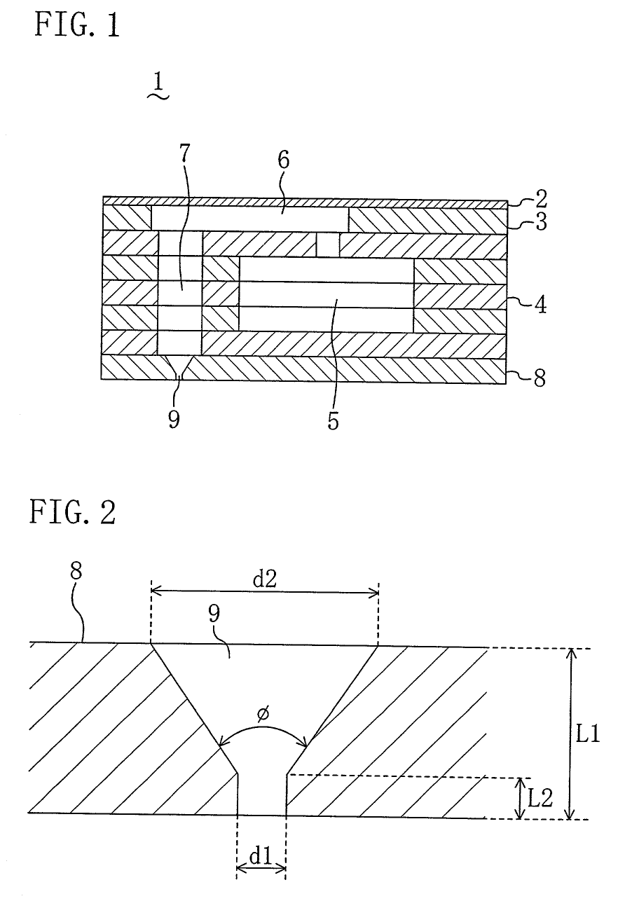

As illustrated in FIG. 1, an ink jet head 1 includes a nozzle plate 8, a head body 4 obtained by layering a plurality of stainless steel plates together, a pressure chamber forming plate 3 made of a photosensitive glass, and a piezoelectric actuator 2, which are layered together. The nozzle plate 8 includes a nozzle 9. Although not shown in FIG. 1, the nozzle plate 8 includes a number of nozzles 9 arranged in a direction perpendicular to the sheet of FIG. 1.

A plurality of pressure chambers 6 communicated to the respective nozzles 9 via ink channels 7, and a common ink chamber 5 communicated to the pressure chambers 6, are provided inside the ink jet head 1.

As illustrated in FIG. 2, an upper portion of the nozzle 9 is tapered so that the inner diameter increases in the upward direction, with a lower portion thereof being a through hole having a constant inner diameter. Although the shape of the nozzle plate 8 and the nozzle 9 is not limited to any particular shape, an example of the nozzle plate 8 and the nozzle 9 that can suitably be used is such that the thickness L1 of the nozzle plate 8 is 50 μm, the length L2 of the through hole having a constant inner diameter is 10 μm, the inner diameter d1 of the through hole is 20 μm, the maximum inner diameter d2 of the tapered portion is 85 μm, and the taper angle Φ is 80°.

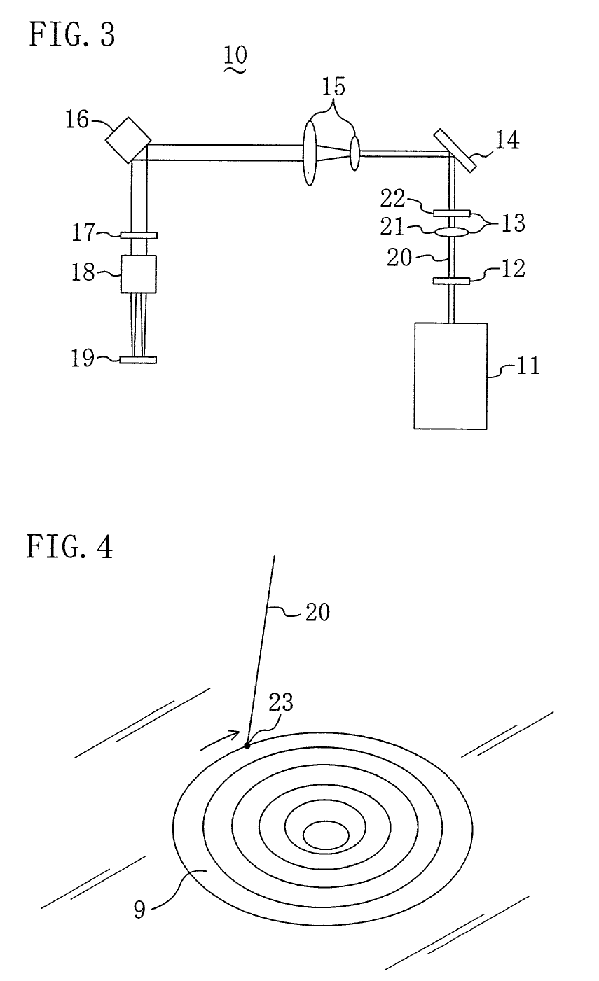

FIG. 3 illustrates a configuration of a laser processing apparatus 10 using an ultra-short pulse laser beam. The laser processing apparatus 10 includes an ultra-short a pulse laser 11 for outputting an ultra-short pulse laser beam at least having a pulse width of 0.1 to 100 ps (pico-second), a shutter 12, an attenuator 13, a first mirror 14, a beam expander 15, a PZT scan mirror 16, a DOE 17, which is a diffraction grating, and a telecentric lens 18. These components are arranged in this order. The attenuator 13, including a phase plate 21 and a polarizer 22, is used for adjusting the intensity of a laser beam 20, which is output from the ultra-short pulse laser 11. Thus, the laser processing apparatus 10 is configured so that the processing energy can be adjusted.

With the laser processing apparatus 10, a workpiece 19 is processed as follows. The laser beam 20 output from the ultra-short pulse laser 11 passes through the shutter 12, and then through the attenuator 13. The laser beam 20, having passed through the attenuator 13, is reflected by the first mirror 14 and expanded by the beam expander 15 with an appropriate magnification so as to be a collimated beam. Then, the collimated laser beam 20 is reflected by the PZT scan mirror 16 and passes through the DOE 17. The laser beam 20 is diffracted by the DOE 17 into a plurality of beams.

The diffracted beams are focused through the telecentric lens 18 so as to vertically reach the surface of the workpiece 19 to be processed, thereby processing the workpiece 19. While the workpiece 19 is processed, the beams can be moved with respect to the workpiece 19 by moving the scan mirror 16. Thus, the processing position can be adjusted by moving the scan mirror 16 as necessary, whereby the workpiece 19 can be processed into an intended shape.

As described above, with the present laser processing apparatus 10, the intensity of the laser beam 20 can be adjusted by the attenuator 13. In the present embodiment, before processing the actual workpiece 19, a power meter is placed in place of the workpiece 19, and the energy level is adjusted based on the measurement results obtained by the power meter.

Next, a method for processing the nozzle plate 8, as the workpiece 19, to form the nozzles 9 therein will be described.

In this processing method, a milling process is performed by scanning the upper surface of the nozzle plate 8 with the laser beam 20 so as to strip off a portion of the nozzle plate 8 from the upper surface. The scanning movement of the laser beam 20 is achieved by swinging the scan mirror 16.

Specifically, a position 23 irradiated with the laser beam 20 is moved in circle about the center of the nozzle 9, as illustrated in FIG. 4. The circular scanning with the laser beam 20 is iterated so as to form circles of successively increasing or decreasing radii about the center of the nozzle 9. As the process proceeds and the hole is dug deeper, the radius of the circle to be scanned by the laser beam 20 is gradually reduced. This can be achieved by first setting the swing angle of the scan mirror 16 to be large in the beginning of the process, and then gradually reducing the swing angle as the process proceeds. In this way, the nozzle 9 having a mortar-like tapered portion is formed.

After forming the tapered portion of the nozzle 9, a central portion of the nozzle 9 is locally trimmed so as to form the through hole having a constant inner diameter.

The nozzle 9 is formed in the nozzle plate 8 as described above. Note that the nozzle plate 8 is irradiated with a plurality of laser beams 20 obtained through the diffraction by the DOE 17, whereby a plurality of nozzles 9 are formed simultaneously in the single nozzle plate 8.

Next, various examples of the processing method will be described.

### EXAMPLE 1

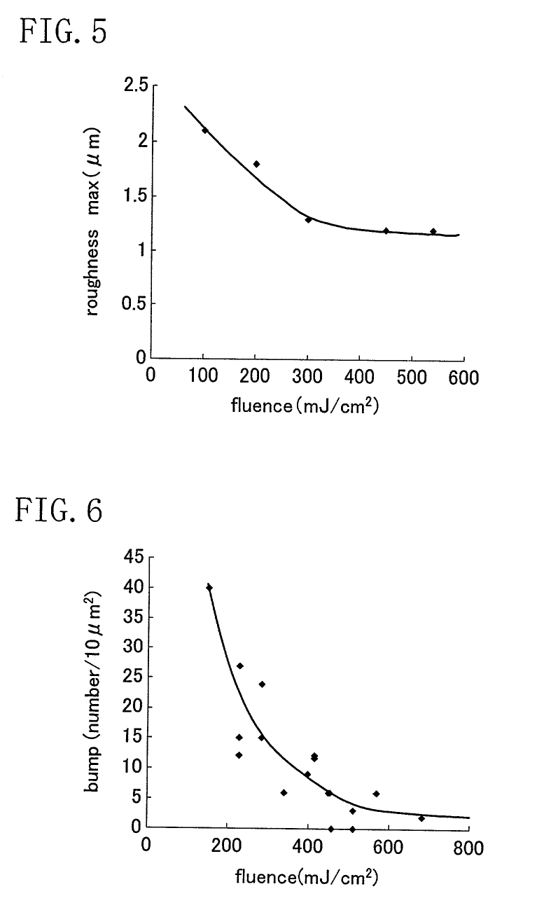

In Example 1, a laser process was performed while using, as a workpiece, a nozzle plate made of a metal such as a stainless steel or Ni. The process was performed with a number of processing energy levels in order to examine the relationship between the processing energy and the surface roughness of the processed surface. The examination results of Example 1 are shown in FIG. 5.

With a prior art processing method, the processing energy was about 80 mJ/cm². Under such a condition, however, the surface roughness of the processed surface was substantial and the processing quality was low. In view of this, processing energy levels higher than that of the prior art were employed in the present example. As a result, it was found that the surface roughness of the processed surface can be reduced by increasing the processing energy, e.g., by employing a processing energy level that is twice as high as that of the prior art. Moreover, it was found that the maximum value of the surface roughness of the processed surface can be significantly reduced by setting the processing energy to be 300 mJ/cm² or more. It was also found that the surface roughness of the processed surface stays at a substantially constant level for processing energy levels of 300 mJ/cm² or more.

Thus, where a nozzle plate made of a metal is processed to form a nozzle therein, it is possible to obtain a high-quality nozzle with a suppressed surface roughness by setting the processing energy to be 300 mJ/cm² or more. By suppressing the surface roughness as described above, the ink flow through the nozzle is made smooth, and it is less likely that an unnecessary disturbance occurs in the ink. Moreover, the ink pressure loss due to the surface roughness in the nozzle is also reduced. Therefore, it is possible to obtain a high-performance nozzle.

By improving the performance of the nozzles of the nozzle plate, the ink discharging direction and the ink discharging velocity become stable and as designed. Therefore, it is possible to obtain a high-performance ink jet head, and to obtain a print in which the printing position, etc., are accurate and the image quality is high.

### EXAMPLE 2

In Example 2, a laser process was performed while using, as a workpiece, a nozzle plate containing one or both of an aluminum oxide and a magnesium oxide. The process was performed with a number of processing energy levels in order to examine the relationship between the processing energy and the frequency of bumps (“bump count”). The examination results of Example 2 are shown in FIG. 6.

FIG. 6 shows the relationship between the processing energy and the bump count per 10 μm² on the processed surface. As can be seen from FIG. 6, it was found that the bump count on the processed surface of the nozzle plate significantly decreases by setting the processing energy to be greater than that of the prior art (about 80 mJ/cm²). Moreover, it was found that the bump count becomes stable at a low level by setting the processing energy to be 400 mJ/cm² or more.

Thus, it was found that where a nozzle plate containing one or both of an aluminum oxide and a magnesium oxide is processed to form a nozzle therein, it is possible to obtain a high-quality nozzle in which the bump or surface roughness is suppressed, by setting the processing energy to be 400 mJ/cm² or more. Therefore, according to the present example, it is possible to suppress bump-like irregularities on the nozzle surface whose size is on the order of microns, which occur in the prior art. Thus, it is possible to prevent a disturbance in the ink flow through the nozzle, and to make the ink flow smooth. The ink discharging direction and the ink discharging velocity become stable, and it is possible to obtain a high-quality print in which the printing position, etc., are accurate.

### EXAMPLE 3

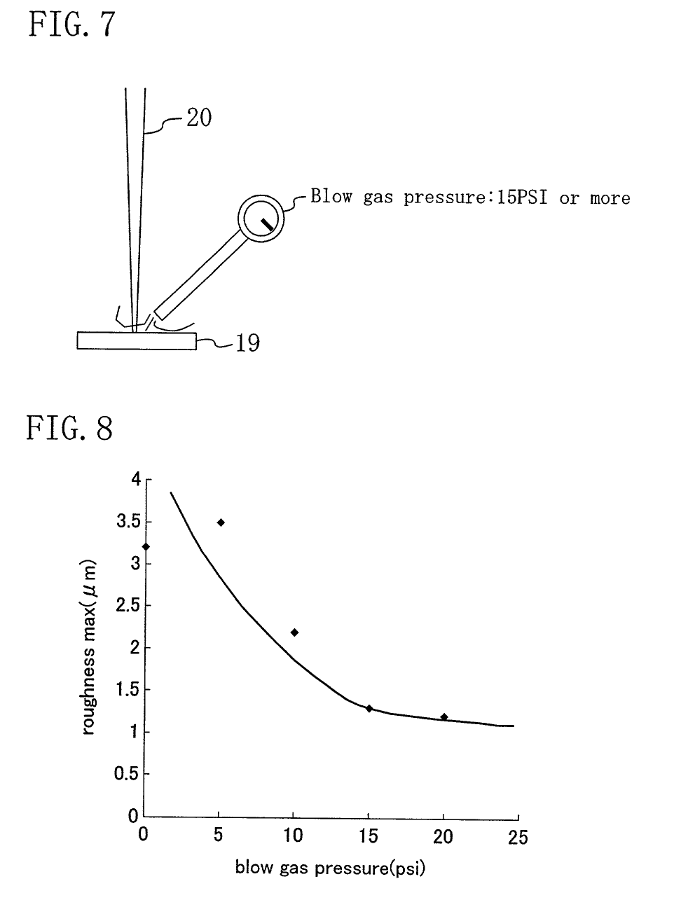

In Example 3, a laser process was performed while blowing an air to the workpiece 19, as illustrated in FIG. 7. The processing energy was set to be about 400 mJ/cm². The process was performed with a number of blow gas pressure levels in order to examine the relationship between the blow gas pressure and the surface roughness of the processed surface. The examination results of Example 3 are shown in FIG. 8.

FIG. 8 shows the relationship between the blow gas pressure and the maximum value of the surface roughness of the processed surface. As can be seen from FIG. 8, it was found that the maximum value of the surface roughness of the nozzle plate significantly decreases by supplying an air with a blow gas pressure of 15 psi or more. Moreover, it was found that the maximum value of the surface roughness stays at a substantially constant value for blow gas pressures of 15 psi or more. Assumedly, this is because chippings, etc., produced during the process are forcibly removed by the air, thus improving the chipping-removing performance. Thus, it was found that the occurrence of bumps on the processed surface or the surface roughness thereof can be reduced by supplying an air at 15 psi or more to the processed surface during the process.

Therefore, also in the present example, it is possible to obtain a high-performance ink jet head, and to obtain a high-quality print, as in Examples 1 and 2.

### EXAMPLE 4

In Example 4, the property of the material of the nozzle plate as a workpiece was modified.

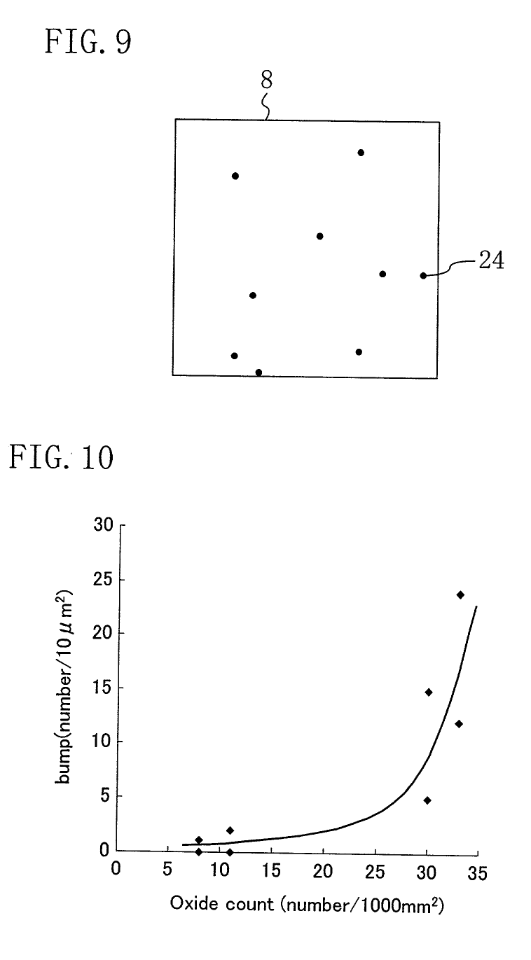

In Example 4, the nozzle plate contained, as an oxide, one or both of an aluminum oxide and a magnesium oxide. In the present example, the amount of oxide to be mixed in the nozzle plate was adjusted. In the experiment of Example 4, the influence of the amount of oxide to be mixed in on the bump count was examined. “Oxide count” (the number of locations per 1000 mm² of an arbitrary cross section of the nozzle plate 8 where an oxide 24 was exposed, as illustrated in FIG. 9) was used as a parameter that represents the amount of oxide mixed in. The oxide count was calculated by using an image processing technique that is well known in the art. The examination results are shown in FIG. 10.

As can be seen from FIG. 10, it was found that the occurrence of bumps in the nozzle can be significantly reduced by setting the amount of oxide to be mixed in so that the oxide count is 20 or less.

Thus, by setting the oxide count to be 20 or less, it is possible to obtain a high-performance ink jet head, and to obtain a high-quality print, as in Examples 1 to 3.

The present invention is not limited to the embodiment or the first to fourth examples set forth above, but may be carried out in various other ways without departing from the sprit or main features thereof. More than one of the first to fourth examples may be employed in combination to obtain an even better process performance.

Thus, the embodiment set forth above is merely illustrative in every respect, and should not be taken as limiting. The scope of the present invention is defined by the appended claims, and in no way is limited to the description set forth herein. Moreover, any variations and/or modifications that are equivalent in scope to the claims fall within the scope of the present invention.

What is claimed is:

1. A laser processing method, comprising the step of processing a workpiece made of a metal by using an ultra-short pulse laser beam, wherein an energy applied on a processed surface of the workpiece is 300 mJ/cm² or more.

2. The laser processing method of claim 1, wherein the workpiece is a nozzle plate of an ink jet head.

3. The laser processing method of claim 1, wherein a pulse width of the ultra-short pulse laser beam is 0.1 ps to 100 ps.

4. The laser processing method of claim 1, wherein:
the workpiece contains an oxide including one or both of an Al oxide and an Mg oxide; and
the energy applied on the processed surface of the workpiece is 400 mJ/cm² or more.

5. The laser processing method of claim 1, wherein a gas is blown to the workpiece being processed with a blow pressure of 15 psi or more.

6. The laser processing method of claim 1, wherein:
the workpiece contains an oxide including one or both of an Al oxide and an Mg oxide; and
the number of locations per 1000 mm² of an arbitrary cross section of the workpiece where the oxide is exposed is 20 or less.

7. The laser processing method of claim 1, wherein:
the workpiece contains an oxide including one or both of an Al oxide and an Mg oxide;
the energy applied on the processed surface of the workpiece is 400 mJ/cm² or more; and
a gas is blown to the workpiece being processed with a blow pressure of 15 psi or more.

8. The laser processing method of claim 1, wherein:
the workpiece contains an oxide including one or both of an Al oxide and an Mg oxide;
the energy applied on the processed surface of the workpiece is 300 mJ/cm² or more; and
the number of locations per 1000 mm² of an arbitrary cross section of the workpiece where the oxide is exposed is 20 or less.

9. The laser processing method of claim 1, wherein:
the workpiece contains an oxide including one or both of an Al oxide and an Mg oxide;
the number of locations per 1000 mm² of an arbitrary cross section of the workpiece where the oxide is exposed is 20 or less; and
a gas is blown to the workpiece being processed with a blow pressure of 15 psi or more.

10. The laser processing method of claim 1, wherein:
the workpiece contains an oxide including one or both of an Al oxide and an Mg oxide;
the energy applied on the processed surface of the workpiece is 300 mJ/cm² or more;
the number of locations per 1000 mm² of an arbitrary cross section of the workpiece where the oxide is exposed is 20 or less; and
a gas is blown to the workpiece being processed with a blow pressure of 15 psi or more.

11. A laser processing method, comprising the step of processing a workpiece by using an ultra-short pulse laser beam, wherein:
the workpiece contains an oxide including one or both of an Al oxide and an Mg oxide; and
the energy applied on the processed surface of the workpiece is 400 mJ/cm² or more.

12. The laser processing method of claim 11, wherein the workpiece is a nozzle plate of an ink jet head.

13. The laser processing method of claim 11, wherein a pulse width of the ultra-short pulse laser beam is 0.1 ps to 100 ps.

14. The laser processing method of claim 11, wherein a gas is blown to the workpiece being processed with a blow pressure of 15 psi or more.

15. The laser processing method of claim 11, wherein:
the workpiece contains an oxide including one or both of an Al oxide and an Mg oxide; and
the number of locations per 1000 mm² of an arbitrary cross section of the workpiece where the oxide is exposed is 20 or less.

16. The laser processing method of claim 11, wherein:
the number of locations per 1000 mm² of an arbitrary cross section of the workpiece where the oxide is exposed is 20 or less; and
a gas is blown to the workpiece being processed with a blow pressure of 15 psi or more.

17. A laser processing method, comprising the step of processing a workpiece made of a metal by using an ultra-short pulse laser beam, wherein a gas is blown to the workpiece being processed with a blow pressure of 15 psi or more.

18. The laser processing method of claim 17, wherein the workpiece is a nozzle plate of an ink jet head.

19. The laser processing method of claim 17, wherein a pulse width of the ultra-short pulse laser beam is 0.1 ps to 100 ps.

20. The laser processing method of claim 17, wherein:
the workpiece contains an oxide including one or both of an Al oxide and an Mg oxide; and
the number of locations per 1000 mm² of an arbitrary cross section of the workpiece where the oxide is exposed is 20 or less.

21. A laser processing method, comprising the step of processing a workpiece by using an ultra-short pulse laser beam, wherein:
the workpiece contains an oxide including one or both of an Al oxide and an Mg oxide; and
the number of locations per 1000 mm² of an arbitrary cross section of the workpiece where the oxide is exposed is 20 or less.

22. The laser processing method of claim 21, wherein the workpiece is a nozzle plate of an ink jet head.

23. The laser processing method of claim 21, wherein a pulse width of the ultra-short pulse laser beam is 0.1 ps to 100 ps.
